(19) United States
(12) Patent Application Publication
(10) Pub. No.: US 2012/0070086 A1
(43) Pub. Date: Mar. 22, 2012

(54) INFORMATION READING APPARATUS AND STORAGE MEDIUM

(75) Inventor: Masaki MIYAMOTO, Akishima city (JP)

(73) Assignee: CASIO COMPUTER CO., LTD., Tokyo (JP)

(21) Appl. No.: 13/233,242

(22) Filed: Sep. 15, 2011

(30) Foreign Application Priority Data
Sep. 17, 2010 (JP) P2010-209371

(51) Int. Cl. G06K 9/46

(52) U.S. Cl. 382/195

(57) ABSTRACT

An information reading apparatus that reads information from an image. The apparatus includes: an acquiring module, a first processing module, a second processing module, and an adding module. The acquiring module acquires a whole image containing plural reading subjects. The first processing module performs processing of extracting particular patterns from the respective reading subjects by performing a pattern analysis on the whole image to identify the reading subjects contained in the whole image. The second processing module performs processing of reading pieces of information from the respective reading subjects and recognizing the read-out pieces of information by analyzing the respective particular patterns extracted by the first processing module. The adding module adds current processing statuses for the respective reading subjects contained in the whole image based on at least one of sets of processing results of the first processing module and the second processing module.

### CROSS REFERENCE TO RELAYED APPLICATION(S)

The present disclosure relates to the subject matters contained in Japanese Patent Application No. 2010-209371 filed on Sep. 17, 2010, which are incorporated herein by reference in its entirety.

### FIELD

The present invention relates to an information reading apparatus and a storage medium for reading information from an image.

### BACKGROUND

In general, for example, entering and dispatching a large number of goods to and from a stack room, or taking inventory are managed by reading bar codes attached to the goods using a bar code reader. However, regularly doing inventory work in which merchandises in stock are checked one by one by collating them with a list takes enormous time and labor. A commodities management system capable of doing such checking work efficiently is known. In this system, the entering and dispatching, the inventory, etc. of commodities are managed by continuously reading bar codes of a large number of commodities stored in a stack room or the like (see JP-A-2000-289810).

### SUMMARY

In the above technique, bar codes (commodity numbers) read from commodities that are actually stored in a storage room are compared with commodity numbers that are registered in advance and newly read commodity numbers are registered as movement data. However, duplicative reading or non-reading may occur in reading bar codes as reading subjects continuously from a large number of commodities in stock

An object of an exemplary embodiment of the present invention is to make it possible to read plural reading subjects properly even if they are read collectively.

According to the invention, there is provided an information reading apparatus that reads information from an image, the apparatus including:

an acquiring module that acquires a whole image containing plural reading subjects;

a first processing module that performs processing of extracting particular patterns from the respective reading subjects by performing a pattern analysis on the whole image to identify the reading subjects contained in the whole image;

a second processing module that performs processing of reading pieces of information from the respective reading subjects and recognizing the read-out pieces of information by analyzing the respective particular patterns extracted by the first processing module; and

an adding module that adds current processing statuses for the respective reading subjects contained in the whole image based on at least one of sets of processing results of the first processing module and the second processing module.

The embodiment of the invention enables proper reading of plural reading subjects properly even if they are read collectively, and enhances practicality.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a block diagram showing basic components of an information reading apparatus.

FIG. 2 shows a display of a whole image taken by shooting a stack of all load packages with a shooting unit 8 at a high resolution.

FIG. 3 shows individual particular patterns that are extracted as reading subjects (bar codes, logotypes, etc.) by performing a pattern analysis on the whole image of FIG. 2.

FIG. 4 shows contents of the management table storing unit M2 that are obtained when the particular patterns of the individual reading subjects existing in the whole image shown in FIG. 3 have been subjected to reading processing (recognition processing).

FIG. 5 illustrates a plane coordinate system for defining the position of each particular pattern in the whole image.

FIG. 6 is a flowchart of a first part of a recognition process (reading process) for reading all reading subjects existing in a whole image and recognizing them collectively.

FIG. 7 is a flowchart following the flowchart of FIG. 6.

FIG. 8 is a flowchart following the flowchart of FIG. 7.

FIG. 9 is a flowchart following the flowchart of FIG. 8.

FIG. 10 shows a state that particular-pattern-unextracted regions of the whole image are divided into plural blocks.

FIG. 11 shows contents of the management table storing unit M2 that are obtained when unextracted regions of the whole image have been divided into plural blocks.

FIG. 12 shows example sets of particular patterns extracted by performing a pattern analysis on n× enlarged images taken.

FIG. 13 shows contents of the management table storing unit M2 that are obtained when particular patterns have been extracted from n× enlarged images taken.

FIG. 14 shows contents of the management table storing unit M2 that are obtained when particular patterns have been extracted a (n×2)× enlarged image taken.

FIG. 15 shows final contents of the management table storing unit M2.

FIG. 16 shows a display of the whole image on which final reading results are superimposed.

FIGS. 17A to 17C show whole images taken by shooting all vehicles in the field of view running on an expressway sequentially at certain time points in a second embodiment.

FIG. 18 is a flowchart of a reading process according to the second embodiment which is a reading process (expressway monitoring process) for reading registration numbers from license plates to monitor vehicles running on an expressway.

FIG. 19 is a flowchart which is a detailed version of a shooting and reading process (step B4 in FIG. 18).

### DETAILED DESCRIPTION OF THE EMBODIMENTS

### First Embodiment

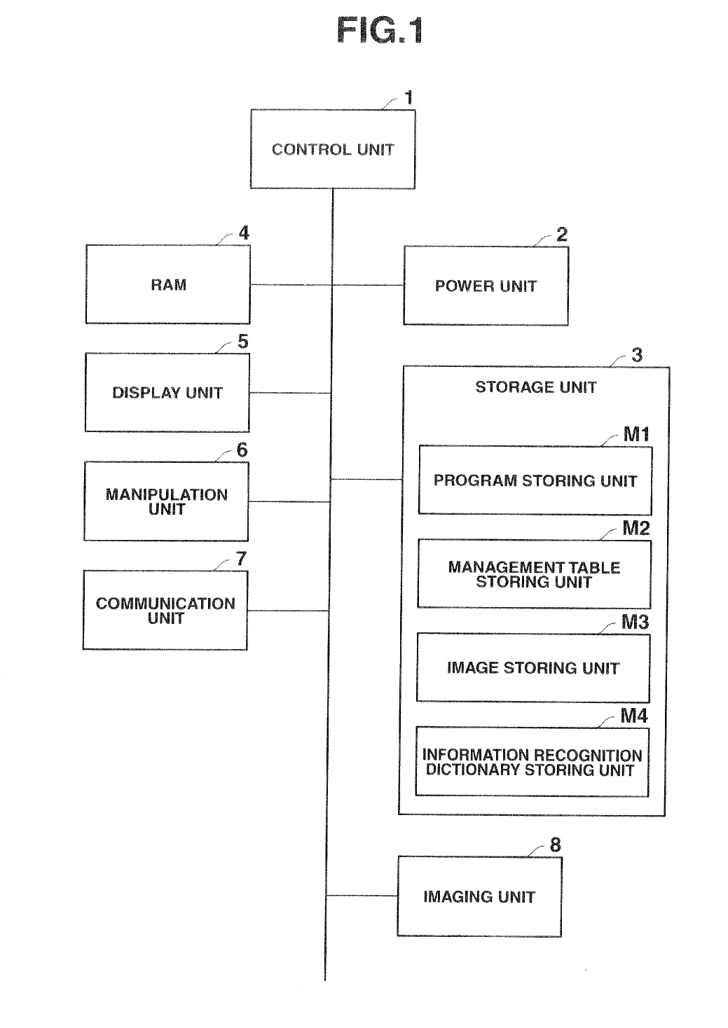

A first embodiment of the present invention will be hereinafter described with reference to FIGS. 1 to 16.

FIG. 1 is a block diagram showing basic components of an information reading apparatus.

Having an imaging function capable of taking a high-resolution image, the information reading apparatus takes a whole image of a stack of all load packages (merchandises) stored in a warehouse or the like by shooting it at a high resolution, extracts particular patterns (image portions such as bar codes) of all reading subjects (e.g., one-dimensional bar codes, two-dimensional bar codes, logotypes, and OCR characters) existing in the whole image by performing a pattern analysis, and analyzes the particular patterns individually. In this manner, all the reading subjects existing in the whole image are read collectively. For example, this information reading apparatus shoots load packages (merchandises) from the front side facing their stacking place (storage place in a warehouse or the like). As such, the information reading apparatus (load monitoring apparatus) is a stationary one that is installed stationarily at a certain location in a warehouse or the like.

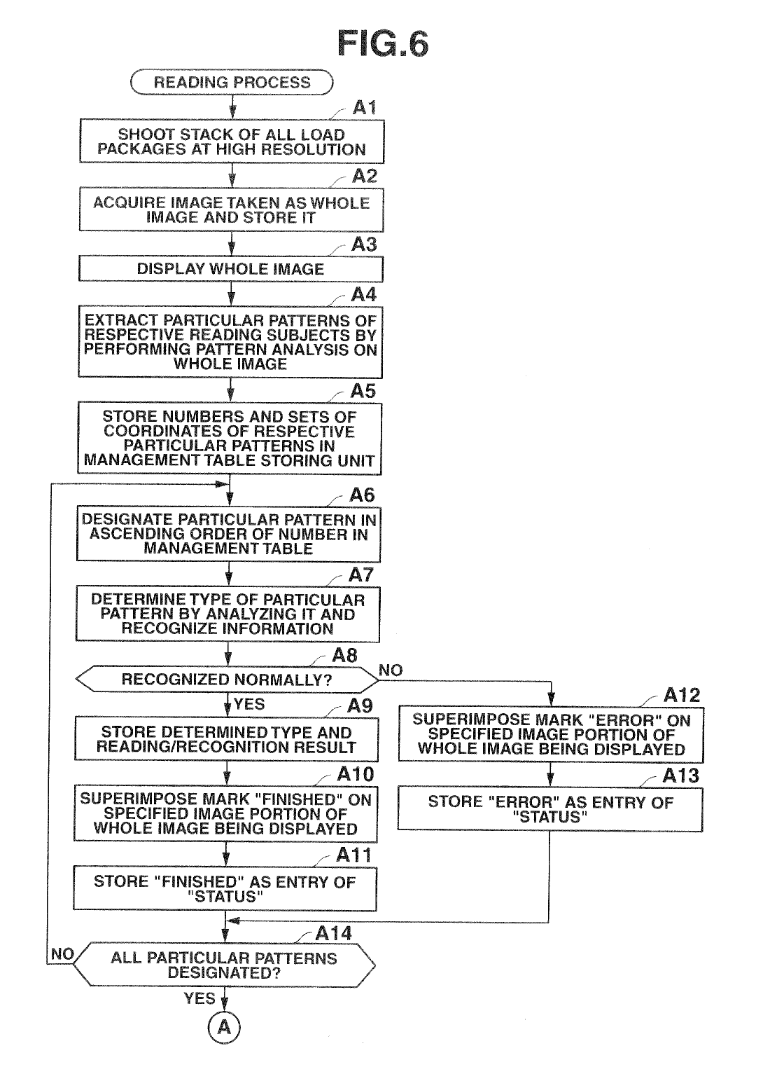

A control unit 1 operates on power that is supplied from a power unit 2 (e.g., commercial power source or secondary battery) and controls the entire operation of the stationary information reading apparatus according to various programs stored in the control unit 1. The control unit 1 is equipped with a central processing unit (CPU)(not shown) and a memory (not shown). Having a ROM, a flash memory, etc., a storage unit 3 has a program storing unit M1 which is stored with a program for implementing the embodiment according to a process shown in FIGS. 6 to 9 and various applications, a management table storing unit M2 for storing reading results of bar codes etc., an image storing unit M3 for storing images taken, and a information recognition dictionary storing unit M4.

A RAM 4 is a work area for temporarily storing various kinds of information such as flag information and picture information that are necessary for operation of the stationary information reading apparatus. A display unit 5, which is, for example, one of a high-resolution liquid crystal display, an organic electroluminescence (EL) display, and an electrophoresis display (electronic paper), is a display device as an external monitor which is separated from the main body of the information reading apparatus and connected to it by wire or through communication. Alternatively, the display unit 5 may be provided in the main body of the information reading apparatus. The display unit 5 serves to display reading results etc. at a high resolution. For example, a capacitance-type touch screen is formed by laying, on the surface of the display unit 5, a transparent touch panel for detecting touch of a finger.

A manipulation unit 6 is an external keyboard which is separated from the main body of the information reading apparatus and connected to it by wire or through communication. Alternatively, the manipulation unit 6 may be provided in the main body of the information reading apparatus. The manipulation unit 6 is equipped with various push-button keys which are a power key, numeral keys, character keys, and various function keys (not shown). The control unit 1 performs various business operations such as inventory management, arrival/shipment inspection, and goods entering/dispatching management according to an input manipulation signal from the manipulation unit 6.

A communication unit 7 serves to send and receive data over a wireless local area network (LAN), a wide area communication network such as the Internet, or the like. For example, the communication unit 7 uploads or downloads data to or from an external storage device (not shown) which is connected via a wide area communication network An imaging unit 8, which serves as a digital camera having a large-magnification of optical ×10 zoom lens and capable of high-resolution shooting, is used for reading bar codes etc. attached to individual merchandises. The imaging unit 8 is provided in the main body of the information reading apparatus and is equipped with an area image sensor such as a C-MOS or CCD imaging device, a range sensor, a light quantity sensor, an analog processing circuit, a signal processing circuit, a compression/expansion circuit, etc. (not shown). In the thus-configured imaging unit 8, optical zooming is adjusted and controlled, auto-focus drive control, shutter drive control, exposure control, white balance control, etc. are performed. Equipped with a bifocal lens and a zoom lens which enable telephoto/wide angle switching, the imaging unit 8 performs telephoto/wide angle shooting. The imaging unit 8 has a shooting direction changing function which can change the shooting direction freely in the vertical and horizontal directions, automatically or manually.

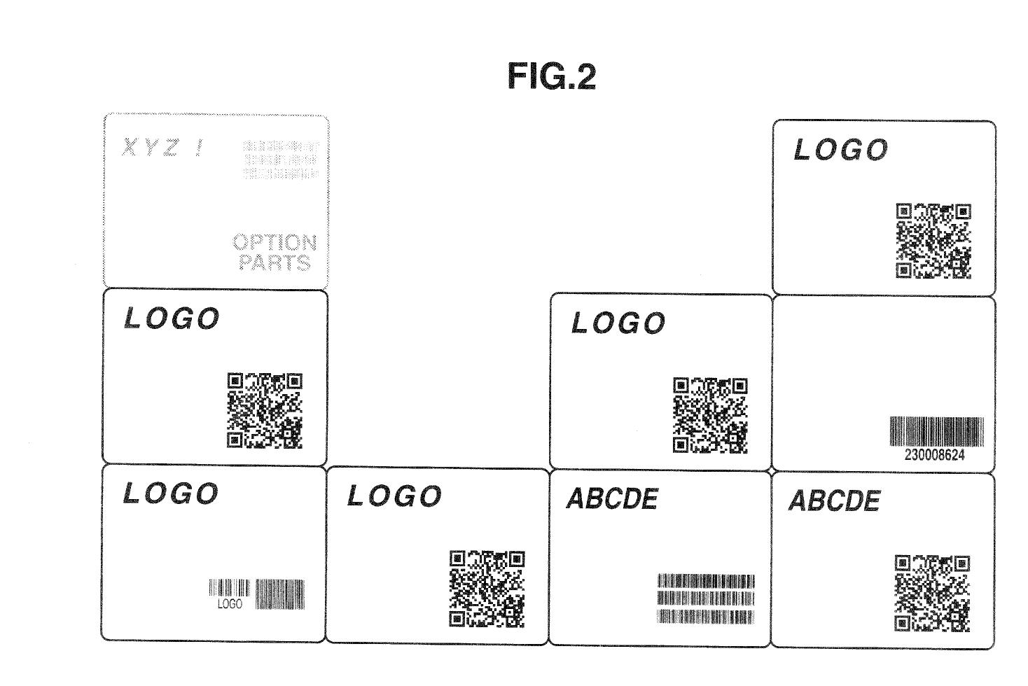

FIG. 2 shows a display of a whole image taken by shooting a stack of all load packages with the shooting unit 8 at a high resolution.

This whole image contains reading subject image portions such as bar codes that are printed on or attached to the surface of individual load packages (rectangular areas in FIG. 2). The control unit 1 identifies, as reading subject regions, data-concentrated portions existing in the whole image by performing a pattern analysis thereon and performs pattern extraction processing for extracting their particular patterns (image portions such as bar codes, logotypes, and OCR characters). The data-concentrated portion is a region that is identified by making a comprehensive determination which involves evaluation of a data concentration density, area, and shape and other factors. These regions are extracted as particular patterns that represent reading subject image portions.

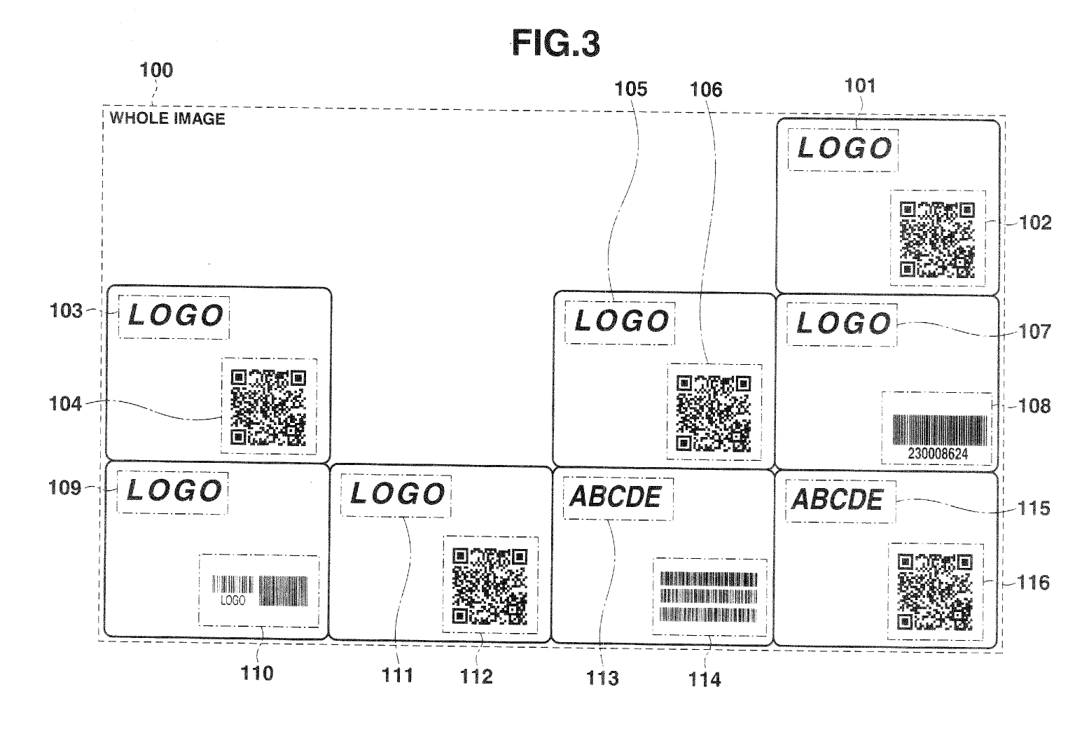

FIG. 3 shows individual particular patterns that are extracted as reading subjects by performing a pattern analysis on the whole image of FIG. 2. In FIG. 3, numeral “100” is an identification number of the whole image which contains reading subjects such as bar codes. Numerals “101” to “116” are particular pattern identification numbers. That is, numerals “101” to “116” are identification numbers (serial numbers) that are assigned serially to particular patterns that are extracted for respective reading subjects existing in the whole image. In the example of FIG. 3, 16 particular patterns 101-106 are extracted from the whole image.

Reading processing which is performed in the embodiment will be outlined below briefly.

In the embodiment, after a whole image which contains reading subjects such as bar codes is acquired by shooting with the imaging unit 8, recognition processing (reading processing) is performed first in which all the reading subjects existing in the whole image are read and recognized collectively by sequentially analyzing individual particular patterns that are extracted in the above-described manner. In the recognition processing, such information as a bar code is recognized by identifying a type of each reading subject and collating it with the contents of the information recognition dictionary storing unit M4.

A status of pieces of processing that have been performed so far is added for each reading subject based on a result of the above-described particular pattern extraction processing and information recognition processing. For example, the processing status for each reading subject is a status that a particular pattern has been extracted from the whole image and its information has been recognized normally (reading completion status), a status that no particular pattern has been extracted from the whole image (non-extraction status), or a status that a particular pattern has been extracted from the whole image but its information has not been recognized normally (reading error status).

In the embodiment, each recognition result with a defect is subjected to the following various kinds of processing (steps (a)to (f)). Where a particular pattern has been extracted from the whole image but its information has not been recognized normally, first, at step (a), the shooting direction is changed and the imaging unit 8 is aimed at the reading subject and then the reading subject with the defect is shot with n× (e.g., 2×) zooming At step (b), an enlarged image taken with n× zooming is subjected to recognition processing. At step (c), if the enlarged image cannot be recognized normally, processing of extracting a particular pattern by performing a pattern analysis on the enlarged image is performed and then an extracted particular pattern is further subjected to recognition processing.

At step (d), if information cannot be recognized normally even by analyzing the enlarged image, magnification is increased so that the portion with the defect is shot with (n×2)× zooming. At step (e), processing of extracting a particular pattern by performing a pattern analysis on an enlarged image taken with (n×2)× zooming is performed and then an extracted particular pattern is further subjected to recognition processing. At step (f), when the particular pattern obtained even with the (n×2)× zooming cannot be recognized normally, to leave the determination to the user (unreadable), processing of storing the enlarged image taken with n× zooming and the enlarged image taken with (n×2)× zooming in such a manner that they are correlated with the reading subject is performed.

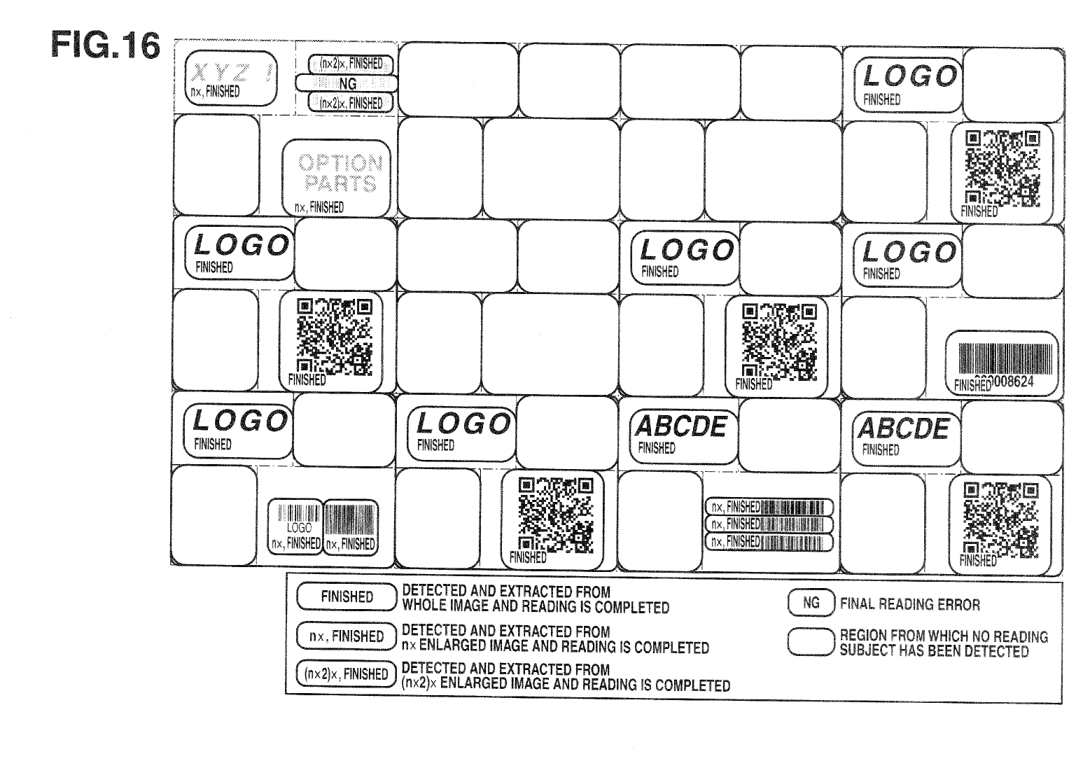

The above-described steps (a) to (f) are directed to the case that a particular pattern has been extracted but information has not been recognized normally by performing recognition processing on the particular pattern. However, to accommodate cases that, for example, a bar code is printed lightly and hence unclear, steps (a) and (c)to (f) are likewise executed for the case that a particular pattern has not been extracted. Information such as “finished” is added (stored) in the management table storing unit M2 as information indicating a processing status of the above procedure so as to be correlated with each reading subject and a mark such as “finished” is displayed additionally so as to be superimposed on each reading subject in the whole image being displayed (described later with reference to FIG. 16).

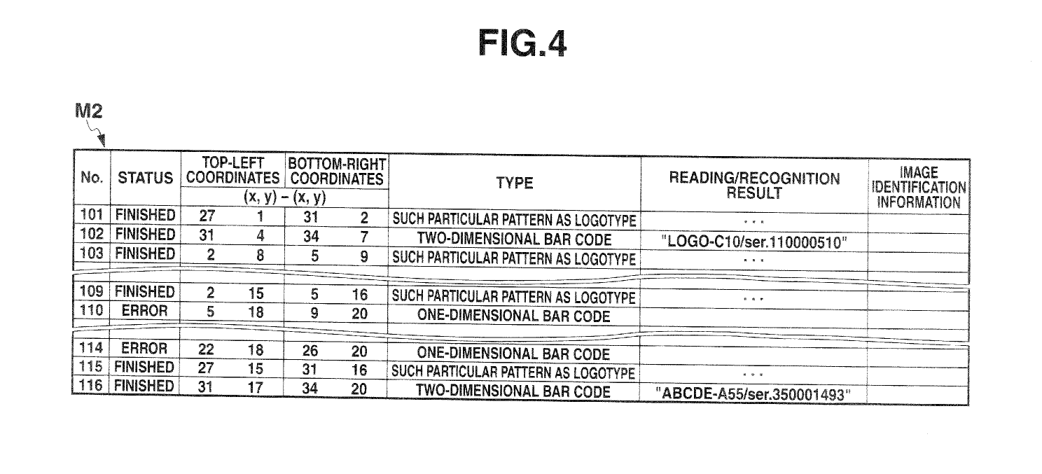

FIG. 4 shows contents of the management table storing unit M2 that are obtained when the particular patterns of the individual reading subjects existing in the whole image shown in FIG. 3 have been subjected to the reading processing (recognition processing).

The management table storing unit M2 serves to manage pieces of read-out information for respective reading subjects (particular patterns), and the management table has items “No.,” “status,” “top-left coordinates,” “bottom-right coordinates,” “type,” “reading/recognition result,” and “image identification information.” The item “No.” is an identification number (e.g., one of “101” to “116”) for identification of each extracted particular pattern (see FIG. 3). The item “status” is a current processing status of a reading subject (particular pattern). “Finished” shown in FIG. 4 means a status that a particular pattern has been extracted from the whole image and information has been recognized normally (reading completion status). “Error” means a status that a particular pattern has been extracted from the whole image but information has not been recognized normally (reading error status).

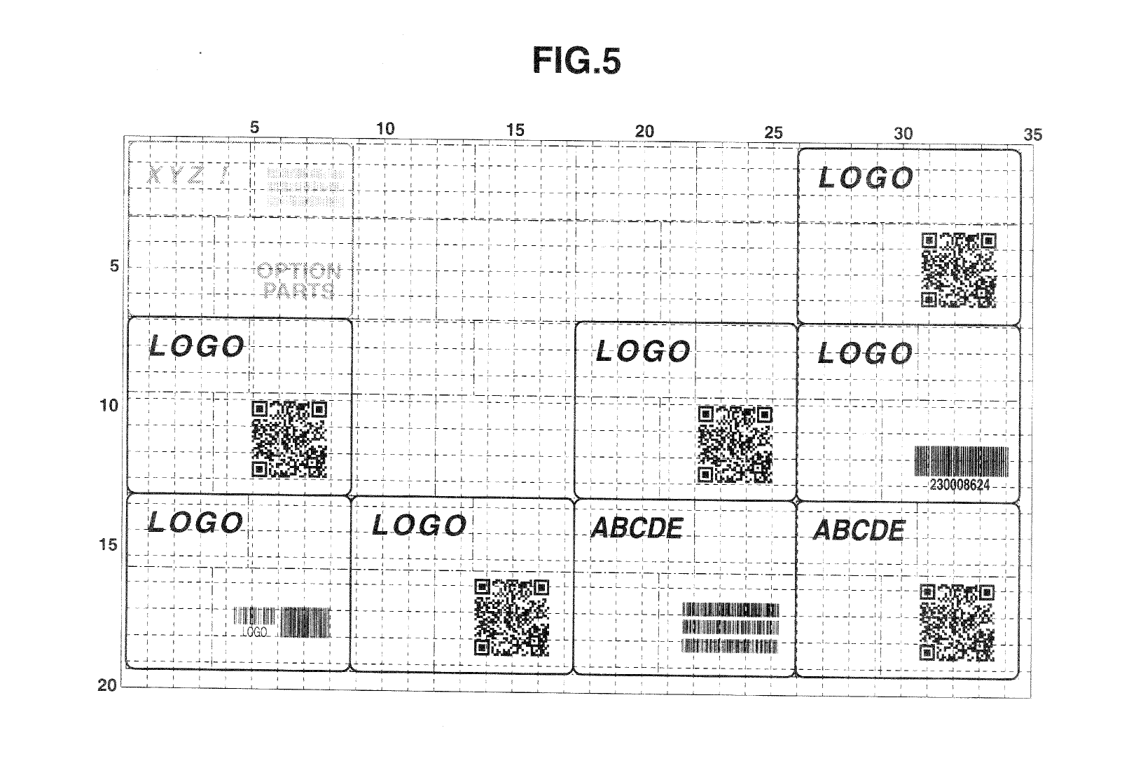

The items “top-left coordinates” and “bottom-right coordinates” are pieces of information (sets of coordinates of two points, that is, the top-left coordinates and the bottom-right coordinates of a rectangular region) for specifying the position and the size of a particular pattern (rectangular region) extracted from the whole image. Where a plane coordinate system shown in FIG. 5 is used whose X axis and Y axis represent the horizontal direction and the vertical direction, respectively, of the whole image, the “top-left coordinates” and the “bottom-right coordinates” of the pattern region having the identification number “101” are (27, 1) and (31, 2), respectively. The “top-left coordinates” and the “bottom-right coordinates” of the pattern region having the identification number “102” are (31, 4) and (34, 7), respectively. Since actual coordinate values are expressed in the number of pixels, the above coordinate values should be multiplied by 10ⁿ, for example, which is the number of pixels of each sideline of one mesh in FIG. 5 (coordinate value “1” of the plane coordinate system).

The item “type” is a type of a reading subject (particular pattern). In the example of FIG. 4, entries of “type” are “such particular pattern as logotype,” “two-dimensional bar code,” and “one-dimensional bar code.” The item “reading/recognition result” is information obtained by recognition processing of a reading subject. As described above, the management table storing unit M2 stores recognition results (reading results) and current processing statuses in such a manner that they are correlated with the respective reading subjects existing in the whole image. The item “image identification information” is information for identification of images stored in the image storing unit M3, that is, information for discrimination between the whole image, an n× enlarged image, or an (n×2)× enlarged image, which consists of a shooting date and time, a shooting place, an image No., etc. The “image identification information” serves to correlate pieces of information stored in the management table storing unit M2 with pieces information stored in the image storing unit M3.

Next, the operation concept of the stationary information reading apparatus according to the first embodiment will be described with reference to flowcharts of FIGS. 6 to 9. Individual functions described in these flowcharts are stored in the form of pieces of readable program code, and operations are performed successively according to those pieces of program codes. Operations may be performed successively according to pieces of program codes that are transmitted over a transmission medium such as a network That is, operations specific to the embodiment can also be performed using programs and data that are supplied externally over a transmission medium rather than stored in a recording medium. This also applies to a second embodiment which will be described later.

FIGS. 6 to 9 are flowcharts of a recognition process (reading process) for reading all reading subjects existing in a whole image and recognizing them collectively.

First, at step A1 in FIG. 6, the control unit 1 activates the imaging unit 8 and causes it to shoot, at a high resolution, a stack of all load packages stored in a warehouse or the like. At step A2, the control unit 1 acquires, as a whole image, an image taken by the imaging unit 8, generates image identification information, and stores it in the image storing unit M3 together with the whole image. At step A3, the control unit 1 monitor-displays the whole image on the entire screen of the display unit 5 in the same manner as shown in FIG. 2.

In this state, at step A4, the control unit 1 performs pattern extraction processing if identifying all reading subjects existing in the whole image by performing a pattern analysis on the whole image and extracting their particular patterns. At step A5, the control unit 1 generates a number, top-left coordinates, and bottom-right coordinates for each extracted particular pattern and stores them in the management table storing unit M2 together with the above-mentioned image identification information of the whole image. In the example of FIG. 2, particular patterns having numbers “101” to “116” are extracted and a number, top-left coordinates, and bottom-right coordinates are stored in the management table storing unit M2 as pieces information relating to each particular pattern together with the image identification information (see FIG. 3).

At step A6, the control unit 1 designates a particular pattern in ascending order of the number by referring to the management table storing unit M2. At step A7, the control unit 1 determines a type (one-dimensional bar code, two-dimensional bar code, logotype, or the like) of the designated particular pattern by reading out its top-left coordinates and bottom-right coordinates and analyzing the image portion specified by the two sets of coordinates, and performs recognition processing of reading and recognizing information by collating the particular pattern with the contents of the information recognition dictionary storing unit M4. At step A8, the control unit 1 judges whether or not information has been recognized normally. If information has been recognized normally (A8: yes), at step A9 the control unit 1 stores the determined type and the recognition result of the reading subject in the management table storing unit M2 as entries of “type” and “reading/recognition result” on the corresponding row of the management table. At step A10, the control unit 1 superimposes a mark “finished” on the specified image portion of the whole image being displayed. At step A11, the control unit 1 stores “finished” in the management table storing unit M2 as an entry of “status” on the corresponding row of the management table to show that information has been recognized normally (reading completion status).

If information has not been recognized normally by performing recognition processing on the particular pattern (A8: no), at step A12 the control unit 1 superimposes a mark “error” on the specified image portion of the whole image being displayed. At step A13, the control unit 1 stores “error” in the management table storing unit M2 as an entry of “status” on the corresponding row of the management table to show that information has not been recognized normally (reading error status). If a type of the reading subject has been determined though information has not been recognized, the determined type may be stored in the management table storing unit M2 as an entry of “status” on the corresponding row of the management table.

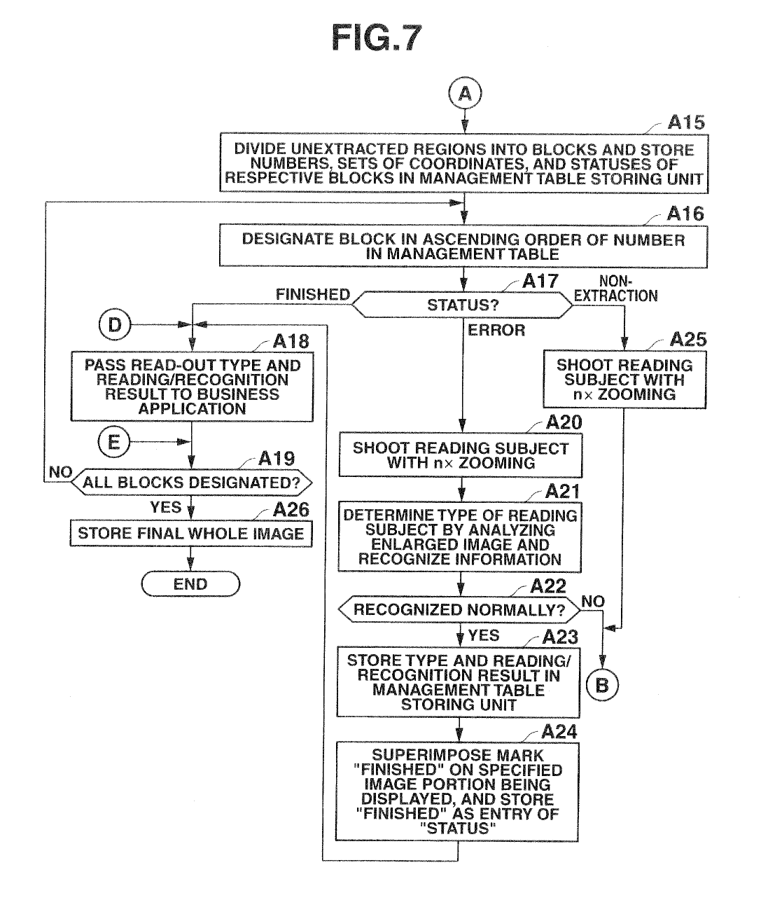

Since the one particular pattern has been processed, the control unit 1 judges at step A14 whether or not all the particular patterns have been designated yet. If not all the particular patterns have been designated yet, the process returns to step A6, when the next particular pattern is designated. When all the particular patterns have been processed, in the example of FIG. 2, the contents of the management table storing unit M2 become as shown in FIG. 4. If all the particular patterns have been processed (A14: yes), the process moves to step A15 in FIG. 7, when the control unit 1 divides particular-pattern-unextracted regions of the whole image into plural blocks having certain sizes, generates numbers, sets of top-left coordinates, and sets of bottom-right coordinates for the respective divisional blocks, makes their status “non-extraction,” and stores these pieces of information in the management table storing unit M2 for the purpose of management. The unextracted regions are divided into plural blocks whose sizes are the same as the sizes of the extracted regions (i.e., the regions (blocks) from which the particular patterns have already been extracted).

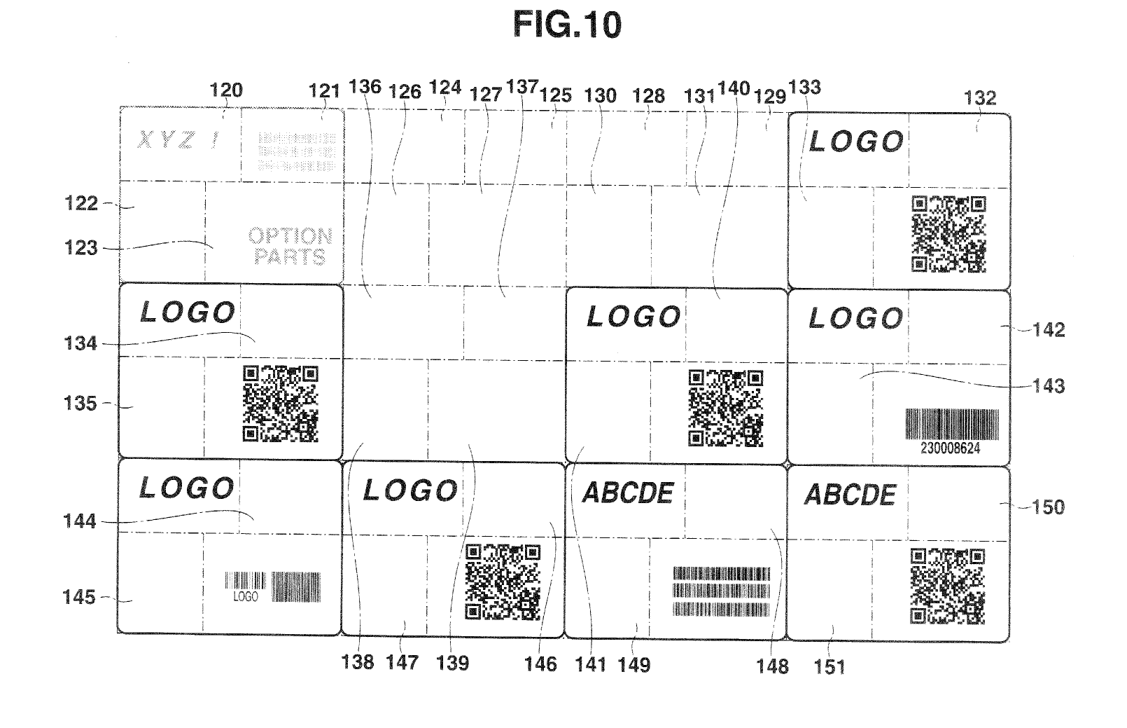

FIG. 10 shows a state that unextracted regions are divided into plural blocks. As described above, the unextracted regions are divided into plural blocks according to the sizes and the arrangement of the particular patterns extracted by performing a pattern analysis on the whole image, that is, so that the plural blocks have the same sizes and arrangement as the particular patterns. In FIG. 10, numbers “120” to “151” are identification numbers that are newly assigned to respective blocks generated by dividing the unextracted regions.

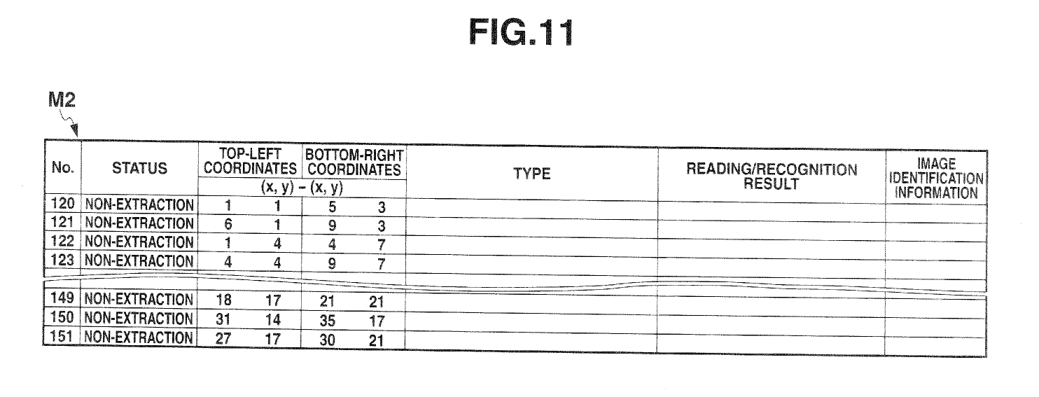

FIG. 11 shows contents of the management table storing unit M2 that are obtained when the unextracted regions of the whole image have been divided into plural blocks. For the newly generated blocks, the identification numbers “120” to “151” are stored as entries of “No.,” “non-extraction” is stored as entries of “status,” and sets of coordinates representing or indicating their positions and sizes are stored as entries of “top-left coordinates” and “bottom-right coordinates.”

At step A16, the control unit 1 designates a block in ascending order of the number by referring to the management table storing unit M2. At step A17, the control unit 1 reads out its status and judges whether it is “finished,” “non-extraction,” or “error.” The block having the number “101” is designated first whose status is “finished.” Therefore, at step A18, the control unit 1 reads, as pieces of read-out information, the type and the reading/recognition result from the management table storing unit M2 and passes them to a business application (e.g., inventory management application). At step A19, the control unit 1 judges whether or not all the blocks have been designated. If not all the blocks have been designated yet, the process returns to step A16, when the next block is designated.

If it is judged at step A16 that the status is “error,” at step A20 the control unit 1 activates the imaging unit 8, changes its direction to aim it at the actual reading subject corresponding to the designated block, and causes it to perform n× (e.g., 2× (optical)) zoom shooting. The shooting direction of the shooting unit 8 is adjusted by determining a position of the block in the whole image based on its top-left coordinates and bottom-right coordinates and calculating a necessary shooting direction change based on the determined position of the block and a distance to the load package (subject) when the whole image was taken. At step A21, recognition processing of determining a type of the reading subject by analyzing an enlarged image taken with n× zooming and reading and recognizing information is performed.

If information has been recognized normally (A22: yes), at step A23 the control unit 1 stores the determined type and the recognition result in the management table storing unit M2. At step A24, the control unit 1 superimposes a mark “finished” on the specified image portion (particular pattern portion) of the whole image being displayed and changes the corresponding entry of “status” in the management table from “error” to “finished.” Then, the process moves to step A18, when the control unit 1 reads, as pieces of read-out information, the type and the reading/recognition result from the management table storing unit M2 and passes them to the business application.

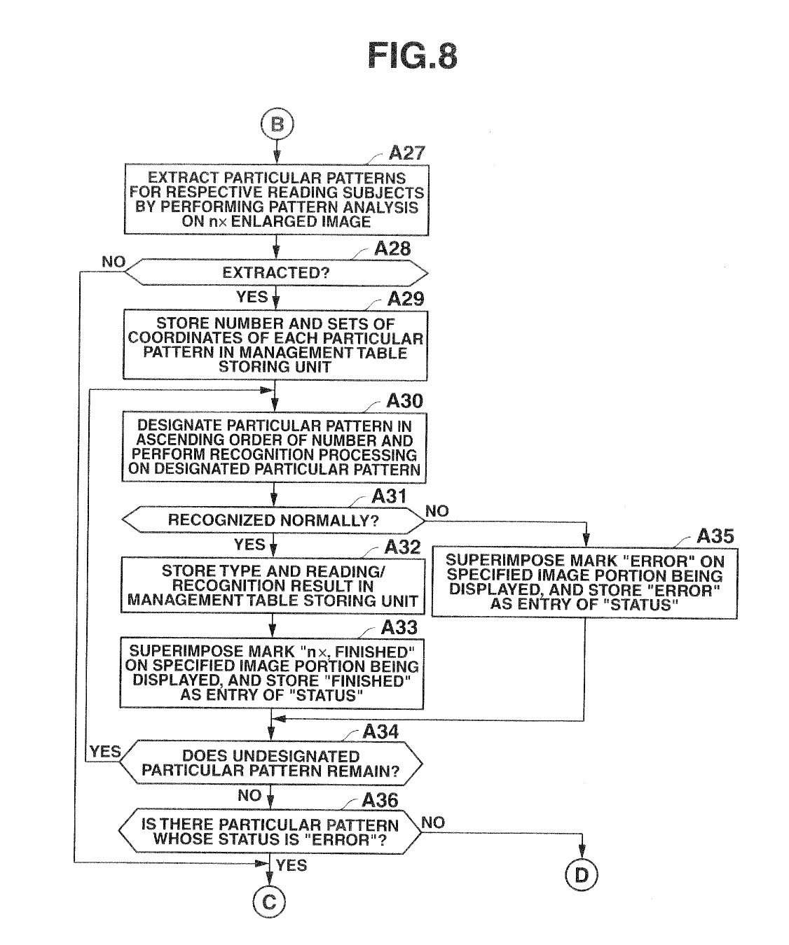

Now assume that the block having the number “110” whose “status” is “error” has been designated at step A17. In this case, at step A20, the imaging unit 8 is aimed at the actual reading subject corresponding to this block and shoot it again with n× zooming At step A21, recognition processing is performed on an image taken. Since the designated block contains two bar codes, it is judged at step A22 that information has not been recognized normally. Therefore, the process moves to step A27 in FIG. 8, when pattern extraction processing of extracting, as particular patterns, all reading subjects existing in the enlarged image by performing a pattern analysis on the enlarged image taken with n× zooming is performed.

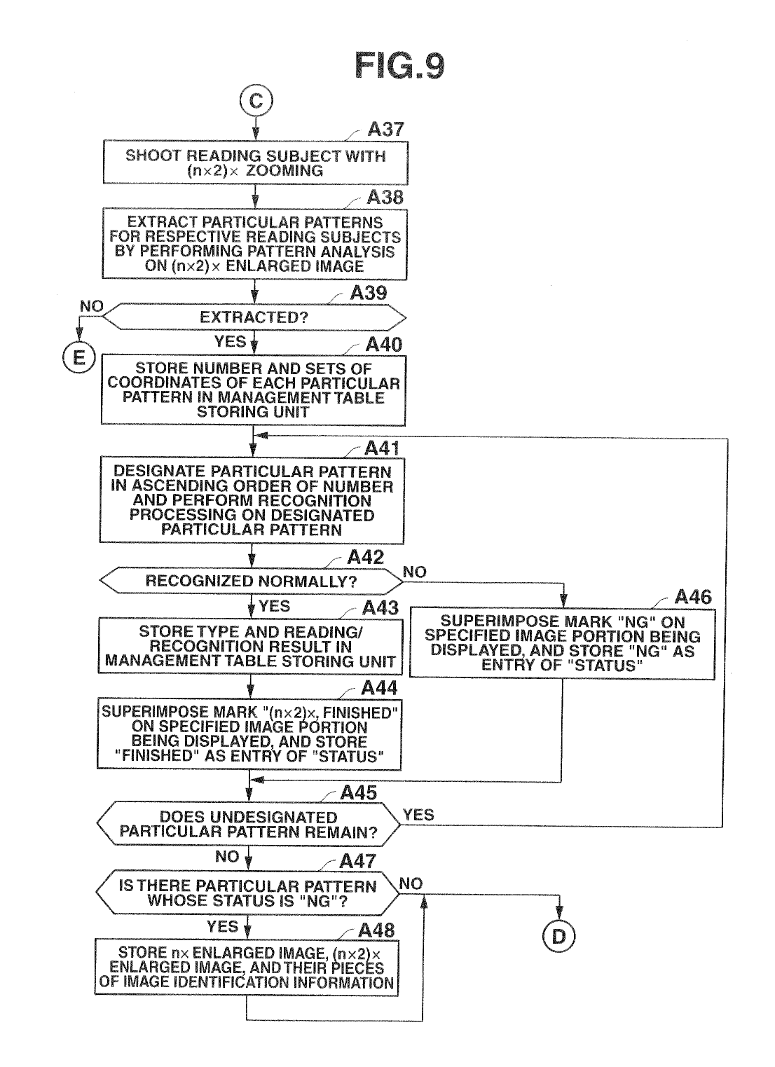

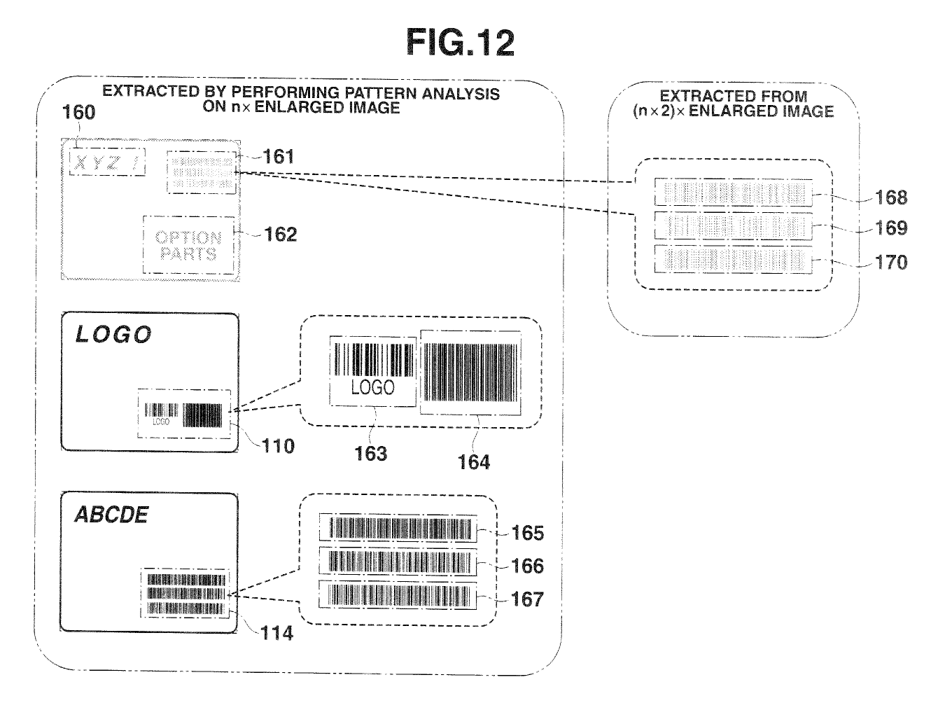

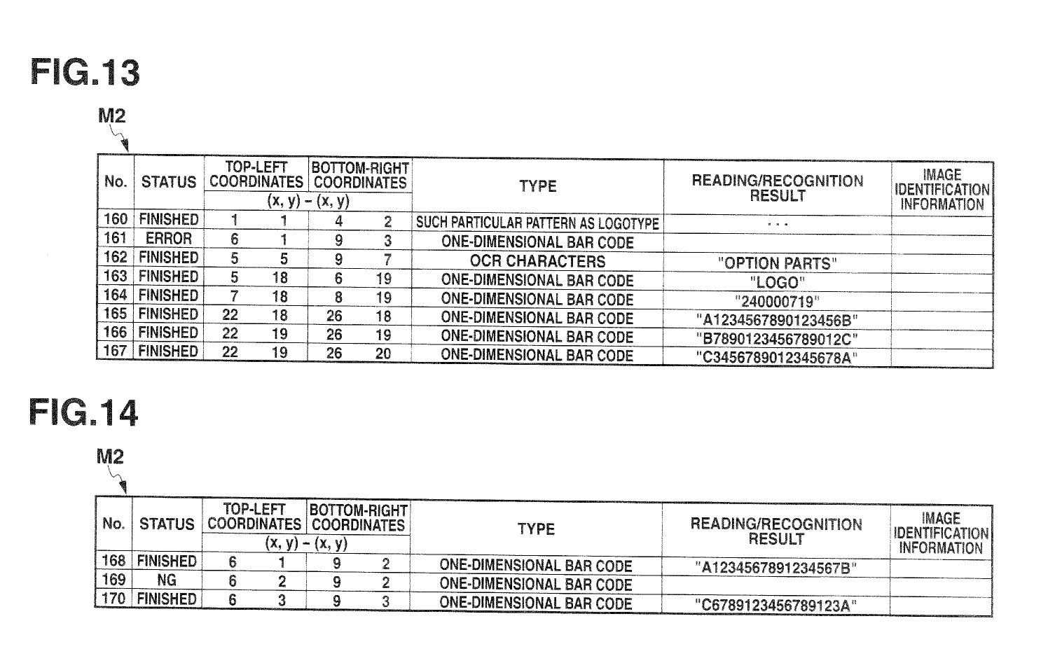

FIG. 12 shows example sets of particular patterns extracted by performing a pattern analysis on n× enlarged images taken. FIG. 13 shows contents of the management table storing unit M2 that are obtained when particular patterns have been extracted from n× enlarged images taken. If no particular pattern is extracted by performing a pattern analysis on the n× enlarged image taken (step A28 in FIG. 8: no), the process moves to the part of the process shown in FIG. 9. On the other hand, if particular patterns have been extracted (A28: yes), at step A29 the control unit 1 generates numbers, sets of top-left coordinates, and sets of bottom-right coordinates for the respective extracted particular patterns and stores them in the management table storing unit M2.

The example shown in the middle part of FIG. 12 is of such a case that the fact that the block having the number “110” contains two one-dimensional bar codes has been found by performing a pattern analysis on that block Particular patterns are extracted for the two respective bar codes. As shown in FIG. 13, new identification numbers “163” and “164” are assigned to the two respective particular patterns and these numbers and their sets of top-left coordinates and sets of bottom-right coordinates are stored in the management table storing unit M2. At step A30, one, having the number “163,” of the newly extracted particular patterns is designated and recognition processing is performed on the designated particular pattern.

If information has been recognized normally (A31: yes), at step A32 the control unit 1 stores a type and a recognition result in the management table storing unit M2 as in step A23 in FIG. 7. At step A33, as in step A24 in FIG. 7, the control unit 1 superimposes a mark “n×, finished” indicating that information has been recognized by n× zoom shooting on the specified image portion being displayed, and rewrite the entry of “status” from “error” to “finished.” At step A34, the control unit 1 judges whether or not the newly extracted particular patterns include an undesignated one(s). Since the particular pattern having the number “164” has not been designated yet (S34: yes), the process returns to step A30, when the next particular pattern is designated.

If information has not been recognized normally by performing recognition processing (A31: no), at step A35 the control unit 1 superimposes a mark “error” on the specified image portion (particular pattern portion) of the whole image being displayed and stores “error” in the management table storing unit M2 as an entry of “status” on the corresponding row. Then, the process moves to step A34 for judging whether an undesignated particular pattern(s) remains or not If all the particular patterns have been designated (A34: no), at step A36 the control unit 1 judges whether the newly extracted particular patterns have an error status. If at least one of the particular patterns has an error status (A36: yes), the process moves to the part of the process shown in FIG. 9. On the other hand, if none of the particular patterns have an error status (A36: no), the process returns to step A18 in FIG. 7, when the current pieces of read-out information are passed to the business application.

In the examples of FIG. 12, when the particular pattern having the number “110” whose status is “error” or the particular pattern having the number “114” whose status is “error” is designated at step A16, the status being “error” is found at step A17 in FIG. 7 and step A20 and the following steps are executed. That is, at step A20, the imaging unit 8 is aimed at the reading subject concerned and shoots the reading subject with n× zooming. At step A21, recognition processing is performed. However, it is judged that information has not been recognized normally (A22: no). Therefore, the process moves to step A27 in FIG. 8, where an enlarged image taken with n× zooming is subjected to a pattern analysis and it is attempted to extract particular patterns. If particular patterns have been extracted (A28: yes), at step A29 a number, top-left coordinates, and bottom-right coordinates are generated for each extracted particular pattern and stored in the management table storing unit M2 for the purpose of management.

The example shown in the bottom part of FIG. 12 is of such a case that the fact that the block having the number “114” contains three one-dimensional bar codes has been found by performing a pattern analysis on that block Particular patterns are extracted for the three respective bar codes. As shown in FIG. 13, new identification numbers “165,” “166,” and “167” are assigned to the three respective particular patterns and these numbers and their sets of top-left coordinates and sets of bottom-right coordinates are stored in the management table storing unit M2. At step A30, a designated particular pattern is subjected to recognition processing. If information is recognized normally from the designated particular pattern (A31: yes), at step A32 a type and a reading result are stored in the management table storing unit M2. At step A33, a mark “n×, finished” is superimposed on the specified image portion being displayed and the status is changed from “error” to “finished.” FIG. 13 corresponds to a case that information has been recognized normally from all the particular patterns having the numbers “165,” “166,” and “167.”

The examples of FIGS. 12 and 13 correspond to a case that two particular patterns and three particular patterns are extracted from the blocks having the numbers “110” and “114,” respectively, and information is recognized normally from all the extracted particular patterns. If information is not recognized normally from one (e.g., the particular pattern having the number “164” or “165”) of those particular patterns, the process moves to the part of the process shown in FIG. 9. The part of the process shown in FIG. 9 is executed when the status of the designated block is “error” and no particular pattern has been extracted from an enlarged image (A28: no) or particular patterns have been extracted but information has not been recognized normally from at least one of the extracted particular patterns (A36: yes).

In the part of the process shown in FIG. 9, first, at step A37, the shooting unit 8 is aimed at the reading subject corresponding to the designated particular pattern and shoots it with (n×2)× zooming Then, steps A38-A47 are executed which are basically the same as respective steps A27-A36 in FIG. 8. Steps A38-A47 are different from steps A27-A36 in FIG. 8 in the following points. If information has been recognized normally by recognition processing (A42: yes), at step A44 a mark “(n×2)×, finished” indicating that information has been recognized by (n×2)× zoom shooting is superimposed on the specified image portion being displayed. Furthermore, if information has not been recognized normally (A42: no), a mark “NG” indicating that processing is impossible is superimposed on the specified image portion being displayed and the status is changed from “error” to “NG” indicating that processing is impossible at step A46 and it is judged at step A47 whether or not there is a particular pattern whose status is “NG” rather than “error.”

If no particular pattern has been extracted by performing a pattern analysis on an enlarged pattern taken with (n×2)× zooming (A39, no), the process returns to step A19 in FIG. 7, when it is judged whether or not all the blocks have been designated. If there is no particular pattern whose status is “NG” (A47: no), the process returns to step A18 in FIG. 7, when pieces of read-out information are passed to the business application. If there is a particular pattern whose status is “NG” (A47: yes), the process moves to step A48, when pieces of image identification information of the n× enlarged image and the (n×2)× enlarged image are generated and these enlarged images are stored in the image storing unit M3 together with their pieces of image identification information. Furthermore, the generated pieces of image identification information are stored in the management table storing unit M2 so as to be correlated with (tied to) the entries of the particular pattern whose status is “NG” Then, the process returns to step A18 in FIG. 7, when the normally read-out pieces of information are passed to the business application and the ones of the particular information whose status is “NG” are not passed to it.

On the other hand, if it is judged at step A16 in FIG. 7 that the status of the designated block is “non-extraction,” at step A25 the imaging unit 8 is activated, its direction is changed so that it is aimed at the actual reading subject corresponding to the designated block, it is caused to shoot the reading subject with n× (e.g., ×2 (optical)) zooming Then, the process moves to part of the process shown in FIG. 8. Unextracted blocks having numbers “120,” “121,” and “123” shown in FIG. 10 come under this category which are printed so lightly that the first pattern analysis could not produce particular patterns. When an image taken this time with n× zooming is subjected to a pattern analysis, as shown in FIG. 12 particular patterns having numbers “160,”, “161,” and “162” are extracted from the respective unextracted blocks “120,” “121,” and “123.”

Information is recognized normally from each of the particular patterns having the numbers “160” and “162.” More specifically, a logotype is recognized from the particular pattern having the number “160” and OCR characters are recognized from the particular pattern having the number “162.”

On the other hand, since the particular pattern having the number “161” contains three one-dimensional bar codes, information cannot be recognized normally from this particular pattern by analyzing it.

If information cannot be recognized normally by n× zoom shooting (step A31 in FIG. 8: no), “error” is stored as its status at step A35. The process moves to the part of the process shown in FIG. 9 via step A36. A pattern analysis is performed on an enlarged image taken with (n×2)×zooming at steps A37 and A38. As shown in FIG. 12, if it is found at step A39 that this particular pattern contains three one-dimensional bar codes, particular patterns are extracted so as to correspond to the three respective one-dimensional bar codes. FIG. 14 shows contents of the management table storing unit M2 that are obtained when these particular patterns have been extracted by performing a pattern analysis on the (n×2)× enlarged image. As shown in FIG. 14, at step A40, identification numbers “168,” “169,” and “170” are newly assigned to the three respective particular patterns and stored as entries of the item “No.” and sets of top-left coordinates and sets of bottom-right coordinates of the respective particular patterns are also stored. At step A41, recognition processing is performed on the particular patterns having the numbers “168,” “169,” and “170” one by one. In the example shown in the top part of FIG. 14, information is recognized normally from the particular patterns having the numbers “168” and “170” but information is not recognized normally from the particular pattern having the number “169.”

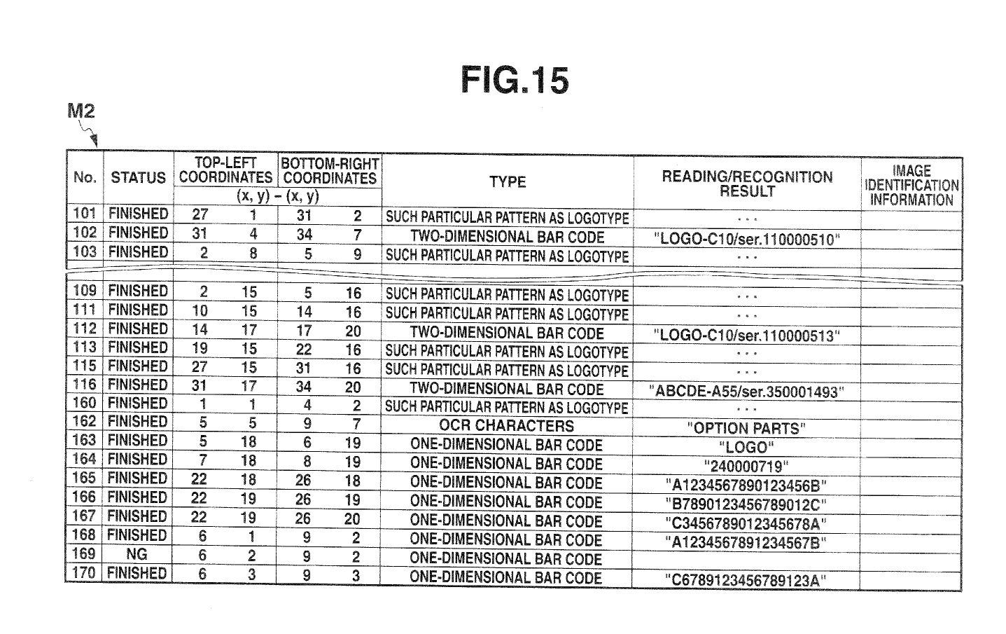

FIG. 15 shows final contents of the management table storing unit M2 that are obtained when all the numbers (i.e., all the particular patterns and blocks) have been designated. All the particular patterns have a status “finished” except the particular pattern having the number “169.” FIG. 16 shows a display of the whole image on which final reading results are superimposed. When all the numbers have been designated, that fact is detected at step A19 in FIG. 7 and the process moves to step A26, when the whole image on which marks “finished” and “NG” are superimposed is stored in the image storing unit M3 as a final whole image. Then, the process of FIGS. 6 to 9 is finished.

In the above-described embodiment, the control unit 1 performs processing of extracting particular patterns from respective reading subjects by performing a pattern analysis on a whole image containing the reading subjects (e.g., bar codes) and processing of recognizing pieces of information (e.g., bar code information) of the respective reading subjects by analyzing the extracted particular patterns. A current processing status is added for each of the reading subjects contained in the whole image based on a result of either of the above two kinds of processing. Therefore, even if reading processing is performed on plural reading subjects collectively, reading can be performed properly without duplicative reading or non-reading. As such, the information reading apparatus according to the embodiment is highly practical.

Since current processing statuses are displayed so as to be associated with image portions of respective reading subjects in a whole image, the user can recognize the current processing statuses. Since a whole image is displayed even during a reading operation, the user can recognize current processing statuses in real time.

Since a whole image with processing statuses that are displayed so as to be associated with image portions of respective reading subjects is stored, the user can recognize current processing statuses freely any time.

Since current processing statuses are stored in the management table storing unit M2 as entries of the item “status,” results of reading processing can be grouped or output as a report according to the processing status.

Since a whole image is taken by shooting plural reading subjects, it can be acquired easily on the spot.

If no particular pattern can be extracted or information cannot be recognized normally, the portion concerned is shot at a certain magnification n and a resulting enlarged image is subjected to particular pattern extraction processing and recognition processing. Therefore, even where a bar code or the like is printed lightly and hence is unclear or plural reading subjects exist, the probability that information is recognized normally by reprocessing which is performed after the enlargement shooting is increased.

If no particular pattern can be extracted or information cannot be recognized normally, the portion concerned is shot at a certain magnification n and a resulting enlarged image is subjected to recognition processing. Therefore, even where, for example, a bar code or the like is printed too small, the probability that information is recognized normally by reprocessing which is performed after the enlargement shooting is increased.

An unextracted region from which no particular pattern could be extracted is divided into blocks having certain sizes, a portion corresponding to each block is shot at a certain magnification, and a resulting enlarged image is subjected to particular pattern extraction processing and recognition processing. Therefore, even for a region when a bar code or the like is printed lightly and hence is unclear and from which a particular pattern could not be extracted, the probability that information is recognized normally by reprocessing which is performed after the enlargement shooting is increased.

An unextracted region from which no particular pattern could be extracted is divided into blocks having certain sizes according to the sizes of extracted particular patterns. This increases the probability that particular blocks are extracted because, for example, particular patterns may exist in the unextracted region in the same forms as the extracted particular patterns.

If information cannot be recognized even by reprocessing which is performed after enlargement shooting of a certain magnification n, the portion concerned is shot again at a magnification (n×2) that is higher than the certain magnification n and a resulting enlarged image is subjected to particular pattern extraction processing and recognition processing. This further increases the probability that information is recognized normally.

Enlarged images taken at the certain magnification n and enlarged images taken at the magnification 2n that is higher than the certain magnification n are stored. This allows the user to find, for example, a reason why information could not be recognized normally by referring to the enlarged images.

In the above-described embodiment, if information is recognized normally by recognition processing, a mark “finished” is superimposed on the image portion concerned. An alternative procedure is as follows. Before a start of reading processing, to indicate that no region has been processed yet, a whole image is shaded in light gray. When information is recognized normally in a certain region, the shading of that region is erased to indicate that information has been recognized normally there in the whole image. This procedure not only provides the same advantages as in the embodiment but also can clarify processing statuses. The manner of display for showing a processing status is arbitrary; for example, a figure including “x” may be superimposed instead of the mark “finished.”

Although in the above-described embodiment the reading subjects are one-dimensional bar codes, two-dimensional bar codes, logotypes, and OCR characters, printed characters, hand-written characters, a mark sheet, images (e.g., packages, books, and faces) may be reading subjects.

The information reading apparatus according to the embodiment has the imaging function capable of taking a high-resolution image and acquires, as a whole image, an image by shooting a stack of all load packages stored in a warehouse or the like at a high resolution. Alternatively, a whole image may be acquired externally in advance via a communication means, an external recording medium, or the like.

The information reading apparatus according to the embodiment is a stationary information reading apparatus which is installed stationarily at a certain location to, for example, shoot load packages from the front side facing their stacking place. Alternatively, the invention can also be applied to a portable handy terminal, an OCR (optical character reader), and the like.

### Second Embodiment

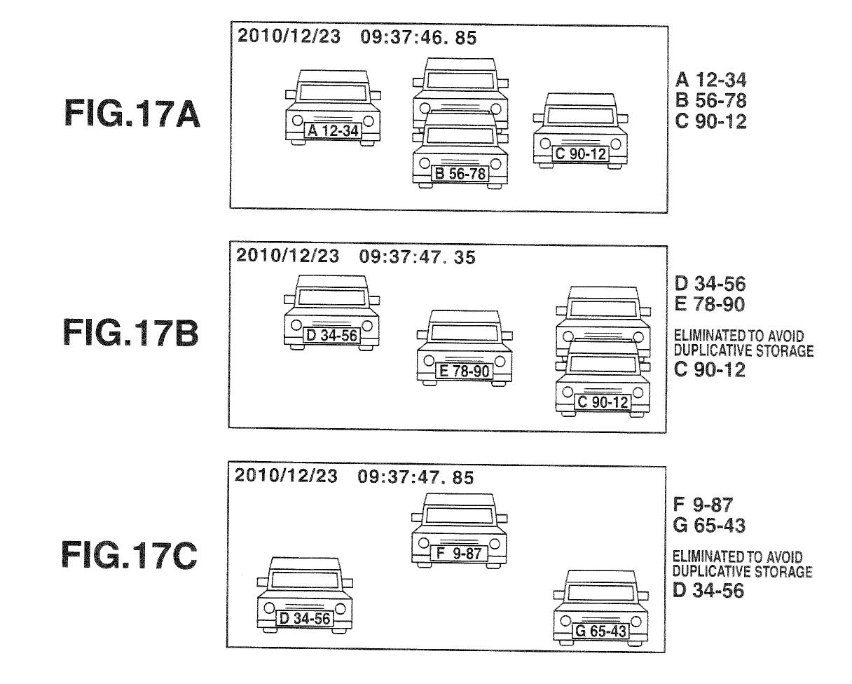

A second embodiment of the invention will be described below with reference to FIGS. 17A to 19.

In the above-described first embodiment, bar codes, logotypes, etc. as reading subjects contained in a whole image that has been taken by shooting a stack of all load packages stored in a warehouse or the like are read collectively. In contrast, the second embodiment is directed to monitoring of vehicles running on an expressway. Each of images taken by shooting all running vehicles within a field of view sequentially at certain time points is acquired as a whole image and registration numbers are read collectively from vehicle license plates as reading subjects contained in each whole image. In the second embodiment, units etc. having the same ones or corresponding ones having the same names as in the first embodiment will be given the same reference symbols and will not be described in detail. Important features of the second embodiment will mainly be described below.

The information reading apparatus according to the second embodiment is a stationary information reading apparatus which is installed stationarily so as to be able to shoot, from above, all vehicles in the field of view that are running on all the lanes on one side of an expressway toward it. The information reading apparatus acquires a whole image by shooting all the lanes on one side at a high resolution, extracts particular patterns of all reading subjects (vehicle license plates) existing in the whole image by a pattern analysis, and analyzes the particular patterns individually. In this manner, registration numbers are read collectively from all the reading subjects existing in the whole image.

FIGS. 17A to 17C show whole images taken by shooting all vehicles in the field of view running on an expressway sequentially at certain time points.

FIG. 17A shows a whole image taken at 9 hours 37 minutes 46 seconds 85, FIG. 17B shows a whole image taken 0.5 second after the shooting time of the whole image of FIG. 17A, and FIG. 17C shows a whole image taken 0.5 second after the shooting time of the whole image of FIG. 17B. In the case of the whole image of FIG. 17A, registration numbers are read from the license plates of three vehicles. The whole image taken is stored in the image storing unit M3 and the read-out registration numbers are stored in the management table storing unit M2.

In the case of the whole image of FIG. 17B, registration numbers are read from two vehicles that have newly appeared and the registration number of one vehicle that was already read from the preceding whole image is read again. The whole image is stored in the image storing unit M3 and the read-out registration numbers of the two vehicles that have newly appeared are stored in the management table storing unit M2. On the other hand, to avoid duplicative storage, the doubly read registration number is once stored in the management table storing unit M2 but then deleted from it. In the case of the whole image of FIG. 17C, registration numbers are read from two vehicles that have newly appeared and the registration number of one vehicle that was already read from the preceding whole image is read again. As in the case of the whole image of FIG. 17B, the whole image is stored in the image storing unit M3 and the read-out registration numbers of the two vehicles that have newly appeared are stored in the management table storing unit M2. On the other hand, to avoid duplicative storage, the doubly read registration number is once stored in the management table storing unit M2 but then deleted from it.

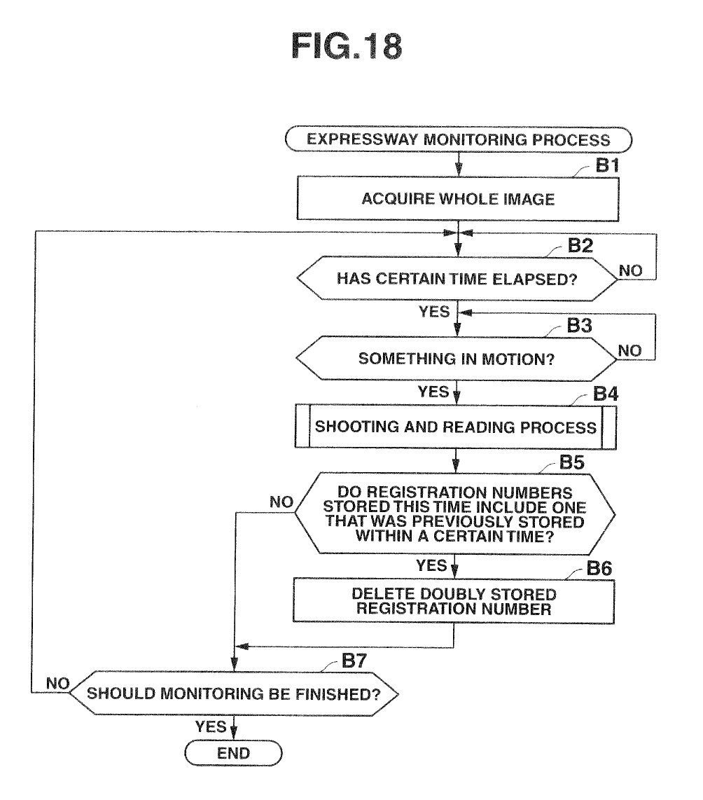

FIG. 18 is a flowchart of a reading process according to the second embodiment which is a reading process (expressway monitoring process) for reading registration numbers from license plates to monitor vehicles running on an expressway. This process is started upon power-on.

First, at step B1, upon power-on, the control unit 1 starts the reading process (expressway monitoring process) and acquires, as a monitoring image, a through-the-lens image by shooting, from above, all the lanes on one side of an expressway. At step B2, the control unit 1 stands by until passage of a certain time (e.g., 0.5 second). If the certain time has elapsed (step B2: yes), at step B3 the control unit 1 analyzes an image taken to check whether or not the image contains something in motion. If image contains something in motion (step B3: yes), at step B4 the control unit 1 executes a shooting and reading process.

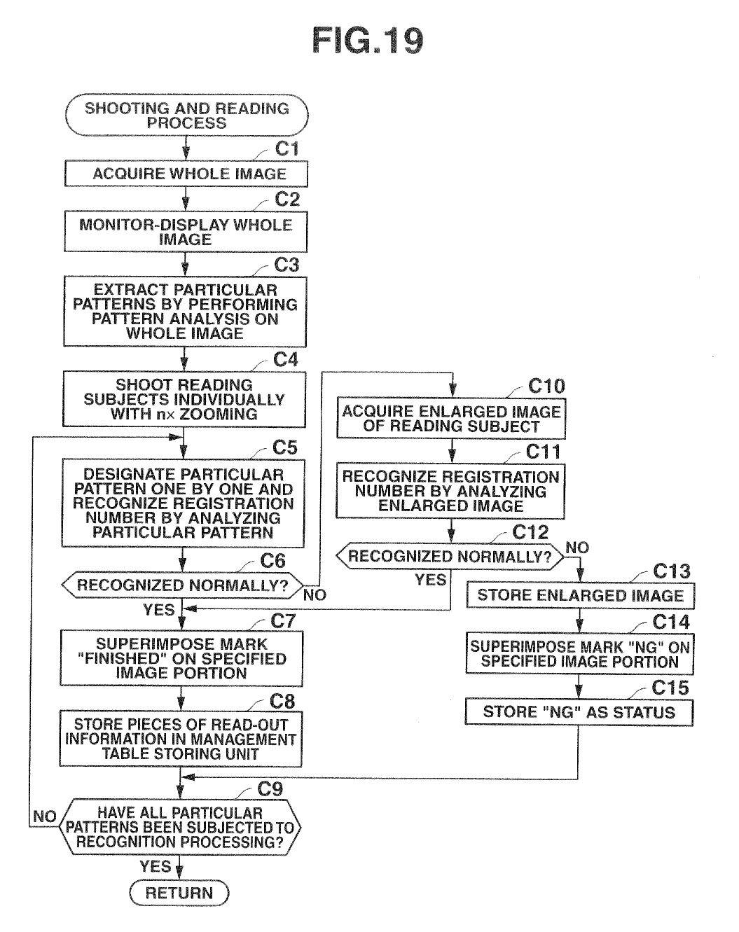

FIG. 19 is a flowchart which is a detailed version of the shooting and reading process (step B4 in FIG. 18).

First, at step C1, the control unit 1 acquires a whole image by shooting all the lanes on one side of the expressway at a high resolution from above with the imaging unit 8. At step C2, the control unit 1 generates its image identification information, stores the generated image identification information in the image storing unit M3 together with the whole image, and monitor-displays the whole image on the display unit 5. At step C3, the control unit 1 extracts particular patterns of all reading subjects (license plates) existing in the whole image by performing a pattern analysis. At step C4, the control unit 1 causes the imaging unit 8 to be aimed at the individual reading subjects (license plates) and shoot them sequentially with n× (e.g., 10×) zooming For example, in the case of the whole image of FIG. 17A, license plates bearing registration numbers “A 12-34,” “B 56-78,” and “C 90-12” are shot in an enlarged manner.

At step C5, the control unit 1 performs recognition processing (reading processing) of designating, one by one, a particular pattern extracted from the whole image and reading and recognizing a registration number from the particular pattern by analyzing the particular pattern. If the license plate bearing the registration number “A 12-34,” for example, is designated and subjected to reading processing and the registration number “A 12-34” is recognized normally (step C6: yes), at step C7 the control unit 1 superimposes a mark “finished” on the image portion of the license plate concerned of the whole image. At step C8, the control unit 1 generates a number, a status, a type, a reading/recognition result, and image identification information as pieces of read-out information of the license plate concerned and stores them in the management table storing unit M2.

The above-mentioned image identification information of the whole image is stored as the image identification information of the license plate concerned, whereby the whole image stored in the image storing unit M3 and the pieces of read-out information stored in the management table storing unit M2 are correlated with (tied to) each other. “Finished” which means a registration number has been recognized normally (reading completion state) is stored as the status. A place name, a vehicle type, or the like is stored as the type and the registration number is stored as the reading/recognition result.

When the recognition processing for the one particular pattern has been completed in the above-described manner, at step C9 the control unit 1 judges whether all the particular patterns have been subjected to recognition processing. If not all the particular patterns have been subjected to recognition processing (step C9: no), the process returns to step C5, when the next particular pattern corresponding to, for example, the license plate bearing the registration number “B 56-78” is designated and subjected to recognition processing. If the registration number “B 56-78” is not recognized normally by the recognition processing (step C6: no), at step A10 the control unit 1 acquires the enlarged image which was taken by shooting the license plate concerned with ×n zooming. At step C11, the control unit 1 performs recognition processing of reading and recognizing a registration number by analyzing the enlarged image. At step C12, the control unit 1 judges whether or not a registration number has been recognized normally.

If a registration number has been recognized normally by analyzing the enlarged image (step C12: yes), the process moves to step C7. On the other hand, if a registration number has not been recognized normally by analyzing the enlarged image (step C12: no), at step C13 the control unit 1 stores the enlarged image in the image storing unit M3 together with its image identification number. At step C14, the control unit 1 superimposes a mark “NG” indicating that reading is impossible on the specified image portion of the whole image.

At step C15, the control unit 1 generates a number, a status, and image identification information and stores them in the management table storing unit M2. “NG” indicating that reading is impossible is stored as the status. Then, the process moves to step C9. The above series of steps are executed repeatedly until it is judged that all the particular patterns have been subjected to recognition processing (step C9: yes). According to this, the registration numbers of the license plates of the three vehicles existing in the whole image of FIG. 17A have been recognized normally and stored in the management table storing unit M2.

If the reading processing for one whole image has been completed (step B4 in FIG. 8), at step B5 the control unit compares the current contents of the management table storing unit M2 with past contents of the management table storing unit M2 (within a certain time (e.g., 1 minute)) and thereby checks whether or not the same registration number(s) is stored. In the whole image of FIG. 17A, it should be judged that no same registration number is stored (step B5: no) because it was taken by the first reading after the power-on. On condition that no instruction to finish the monitoring is received (step B7: no), the process returns to step B2. An instruction to finish the monitoring is given by a user manipulation or after a lapse of a certain time.

If the whole image of FIG. 17B has been taken and subjected to reading, registration numbers “D 34-56” and “E 78-90” of two vehicles that have newly appeared are stored in the management table storing unit M2. On the other hand, a registration number “C 90-12” of one vehicle is the same as one of the registration numbers stored last time (step B5: yes), and hence is once stored in the management table storing unit M2 but then deleted from it to avoid duplicative storage (step B6). Likewise, if the whole image of FIG. 17C has been taken and subjected to reading next to the whole image of FIG. 17B, registration numbers “F 9-87” and “G 65-43” of two vehicles that have newly appeared are stored in the management table storing unit M2. On the other hand, a registration number “D 34-56” of one vehicle is the same as one of the registration numbers stored last time (taken from the whole image of FIG. 17B) (step B5: yes), and hence is once stored in the management table storing unit M2 but then deleted from it to avoid duplicative storage (step B6).

As described above, in the second embodiment, whole images are taken and acquired at certain time points and, if pieces of information recognized from individual reading subjects of a whole image include one that was also recognized from the preceding whole image, duplicative storage of that information is avoided. Therefore, even when all reading subjects are read collectively from each of whole images taken at certain time points, duplicative storage of the same information can be prevented effectively and reading can thus be performed properly.

In the above-described second embodiment is directed to the reading process for reading registration numbers from license plates to monitor vehicles running on an expressway. The second embodiment can also be applied to a process for reading product numbers, printing states of a logotype, or the like to monitor an assembly-line manufacturing process. Although in the second embodiment the certain time points have a 0.5 second interval, the interval is arbitrary and may be switched repeatedly between 0.5 second and 1 second.

Although the above-described second embodiment is directed to the stationary information reading apparatus which is installed stationarily, the second embodiment can also be applied to a portable information reading apparatus. In this case, a worker takes images at certain time points while, for example, moving from one load stacking place to another. Even if the worker takes images at the same place, duplicative storage of the same reading subjects can be prevented. Therefore, when a worker takes images sequentially while, for example, moving from one load stacking place to another, he or she need not determine shooting places in a strict manner. This makes it possible to increase the total work efficiency.

The information reading apparatus according to each embodiment need not always be incorporated in a single cabinet and blocks having different functions may be provided in plural cabinets. Furthermore, the steps of each flowchart need not always be executed in time-series order; plural steps may be executed in parallel or independently of each other.

What is claimed is:

1. An information reading apparatus that reads information from an image, the apparatus comprising:
an acquiring module that acquires a whole image containing plural reading subjects;
a first processing module that performs processing of extracting particular patterns from the respective reading subjects by performing a pattern analysis on the whole image to identify the reading subjects contained in the whole image;
a second processing module that performs processing of reading pieces of information from the respective reading subjects and recognizing the read-out pieces of information by analyzing the respective particular patterns extracted by the first processing module; and
an adding module that adds current processing statuses for the respective reading subjects contained in the whole image based on at least one of sets of processing results of the first processing module and the second processing module.

2. The information reading apparatus according to claim 1, further comprising a display controlling module that displays the current processing statuses added by the adding module on image portions of the respective reading subjects in the whole image.

3. The information reading apparatus according to claim 2, comprising a storage module that stores the whole image which is being displayed in such a manner that the current processing statuses added by the adding module are displayed on the image portions of the respective reading subjects in the whole image.

4. The information reading apparatus according to claim 1, further comprising a reading result storage module that stores, as reading results, identifiers of the respective reading subjects and the processing statuses added by the adding module in such a manner that each of the identifiers and each of the processing statuses are correlated with each other.

5. The information reading apparatus according to claim 1, further comprising a first imaging module that takes a whole image containing plural reading subjects,
wherein the acquiring module acquires the whole image taken by the first imaging module.

6. The information reading apparatus according to claim 1, further comprising a second imaging module that shoots a portion with a defect in an enlarged manner at a certain magnification when the first processing module fails to extract a particular pattern from a reading subject or the second processing module fails to recognize information from a reading subject,
wherein the first processing module extracts a particular pattern by performing a pattern analysis on an enlarged image taken by the second imaging module; and
wherein the second processing module reads and recognizes information by analyzing the particular pattern extracted from the enlarged image by the first processing module.

7. The information reading apparatus according to claim 6, wherein the second imaging module shoots a portion with a defect in an enlarged manner at a certain magnification and the second processing module reads and recognizes information by analyzing an enlarged image taken by the second imaging module when the first processing module fails to extract a particular pattern from a reading subject or the second processing module fails to recognize information from a reading subject

8. The information reading apparatus according to claim 6, further comprising a dividing module that divides an unextracted region into blocks having certain sizes,
wherein the first processing module fails to extract a particular pattern from the unextracted region,
wherein the second imaging module shoots a portion corresponding to each of the blocks produced by the dividing module in an enlarged manner at a certain magnification,
wherein the first processing module extracts a particular pattern by performing a pattern analysis on an enlarged image taken by the second imaging module; and
wherein the second processing module reads and recognizes information by analyzing the particular pattern extracted from the enlarged image by the first processing module.

9. The information reading apparatus according to claim 8, wherein the dividing module divides the unextracted region into blocks having certain sizes based on a size of an extracted particular pattern.

10. The information reading apparatus according to claim 6, wherein the second imaging module shoots a portion with a defect in an enlarged manner at a higher magnification that is higher than the certain magnification when the first processing module fails to extract a particular pattern from the enlarged image or the second processing module fails to recognize information by analyzing the particular pattern extracted from the enlarged image,
wherein the first processing module extracts a particular pattern by performing a pattern analysis on an enlarged image taken at the higher magnification; and
wherein the second processing module reads and recognizes information by analyzing the particular pattern extracted from the enlarged image taken at the higher magnification by the first processing module.

11. The information reading apparatus according to claim 10, further comprising a storage module that stores the enlarged image taken at the certain magnification and the enlarged image taken at the higher magnification that is higher than the certain magnification.

12. The information reading apparatus according to claim 1, further comprising:
an information storage module that stores processing results of the second processing module; and
a storage controlling module that prevent storing into the information storage module,
wherein the acquiring module acquires plural whole images taken sequentially, the plural whole images including a first whole image and a second whole image,
wherein the second processing module performs a processing of reading and recognizing pieces of information from each of the whole images acquired by the acquiring module, and
wherein the storage controlling module prevents duplicative storage of the same information when processing results on the first whole image and the second whole image by the second processing module have the same information.

13. A computer-readable storage medium that stores a program for causing a computer to execute procedures comprising:
acquiring a whole image containing plural reading subjects;
performing first processing of extracting particular patterns from the respective reading subjects by performing a pattern analysis on the whole image to identify the reading subjects contained in the whole image;
performing second processing of recognizing pieces of information from the respective reading subjects by analyzing the respective extracted particular patterns; and
adding current processing statuses for the respective reading subjects contained in the whole image based on at least one of sets of processing results of the first processing and the second processing.
